(19) United States
(12) Patent Application Publication
(10) Pub. No.: US 2026/0064056 A1
(43) Pub. Date: Mar. 5, 2026

(54) IMAGE FORMING APPARATUS

(71) Applicant: KYOCERA Document Solutions Inc., Osaka (JP)

(72) Inventor: Keiju Ishida, Osaka (JP)

(21) Appl. No.: 19/306,352

(22) Filed: Aug. 21, 2025

(30) Foreign Application Priority Data
Aug. 29, 2024 (JP) 2024-147505

(51) Int. Cl. G03G 15/20; G03G 21/16; G03G 21/20

(52) U.S. Cl. CPC G03G 15/2053; G03G 15/2064; G03G 21/1633; G03G 21/1647; G03G 21/206

(57) ABSTRACT

A unit movement mechanism causes a heating unit to move in conjunction with a movement of an operation member. A pair of fans are arranged with an interval provided therebetween in a first direction and blow air toward the heating unit. The heating unit includes a ventilation duct including a hollow portion formed along the first direction, a pair of inflow openings which are formed opposite to the pair of fans, and a discharge opening which is formed between the pair of inflow openings in the first direction. The unit movement mechanism includes a unit coupling member and a link mechanism. The unit coupling member is coupled to the heating unit while a gap is provided between the unit coupling member and the discharge opening.

### INCORPORATION BY REFERENCE

This application is based upon and claims the benefit of priority from the corresponding Japanese Patent Application No. 2024-147505 filed on Aug. 29, 2024, the entire contents of which are incorporated herein by reference.

### BACKGROUND

The present disclosure relates to an image forming apparatus that uses electrophotography and includes a heating unit and a fixing unit.

An image forming apparatus that uses electrophotography transfers a toner image from an image-carrying member onto a sheet, and fixes the toner image onto the sheet using a fixing device.

The fixing device may be sectioned into a heating unit including a heater and a fixing unit including a fixing member and a pressure roller. The heater heats the fixing member.

Further, the image forming apparatus is known to include a mechanism which moves the heating unit from a heating position to an evacuation position in conjunction with an operation to an operation portion. When the heating unit is evacuated to the evacuation position, the fixing unit can be drawn out from a main body.

### SUMMARY

An image forming apparatus according to an aspect of the present disclosure includes a main body, a fixing unit, a heating unit, an operation member, a unit movement mechanism, and a pair of fans. The main body is formed with an exposure opening through which an inside is exposed to an outside. The fixing unit is arranged along a first direction on an inner side of the exposure opening in the main body, and includes a fixing member which is heated and a pressure member which biases a sheet toward the fixing member. The heating unit is arranged in the main body along the first direction while being arranged next to the fixing unit in a second direction orthogonal to the first direction, and includes a heater which heats the fixing member. The operation member is capable of moving by being operate. The unit movement mechanism is arranged on a side opposite to a side of the fixing unit in the second direction with respect to the heating unit in the main body, and causes the heating unit to move between a reference position provided along the fixing unit and an evacuation position farther away from the fixing unit than the reference position in conjunction with a movement of the operation member. The pair of fans are arranged with an interval provided therebetween in the first direction on a side opposite to a side of the heating unit in the second direction with respect to the unit movement mechanism in the main body, and blow air toward the heating unit. When the heating unit is present at the evacuation position, the fixing unit can be drawn out from inside the main body along the first direction. The heating unit includes a ventilation duct including a hollow portion formed along the first direction, a pair of inflow openings which are formed opposite to the pair of fans and are in communication with the hollow portion, and a discharge opening which is formed between the pair of inflow openings in the first direction and is in communication with the hollow portion. The unit movement mechanism includes a unit coupling member which is coupled to the heating unit while a gap is provided between the unit coupling member and the discharge opening at a position between the pair of inflow openings in the first direction, and a link mechanism which transmits the movement of the operation member to the unit coupling member.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an image forming apparatus according to an embodiment;

FIG. 2 is a diagram showing a part of a fixing device in the image forming apparatus according to the embodiment;

FIG. 3 is a perspective view of a main body frame in the image forming apparatus according to the embodiment;

FIG. 4 is a front view of the fixing device in a proximity state in the image forming apparatus according to the embodiment;

FIG. 5 is a front view of the fixing device in a separated state in the image forming apparatus according to the embodiment;

FIG. 6 is a perspective view of a fixing unit in the image forming apparatus according to the embodiment;

FIG. 7 is a plan view of the fixing device and a unit movement mechanism in a biased state in the image forming apparatus according to the embodiment;

FIG. 8 is a plan view of the fixing device and the unit movement mechanism in a pulled state in the image forming apparatus according to the embodiment;

FIG. 9 is a perspective view in which a part of a movable member in the image forming apparatus according to the embodiment is omitted;

FIG. 10 is a plan view of a coupling mechanism of a unit coupling member when the unit movement mechanism in the image forming apparatus according to the embodiment is in the biased state;

FIG. 11 is a plan view of the coupling mechanism of the unit coupling member when the unit movement mechanism in the image forming apparatus according to the embodiment is in the pulled state; and

FIG. 12 is a perspective view showing a part of a first link member and a part of a restriction frame member in the image forming apparatus according to the embodiment.

### DETAILED DESCRIPTION

Hereinafter, an embodiment of the present disclosure will be described with reference to the drawings. It is noted that the following embodiment is an example of embodying the present disclosure and does not limit the technical scope of the present disclosure.

### [Configuration of Image Forming Apparatus 10]

An image forming apparatus 10 according to the embodiment executes print processing using electrophotography. The print processing is processing of forming an image on a sheet 900.

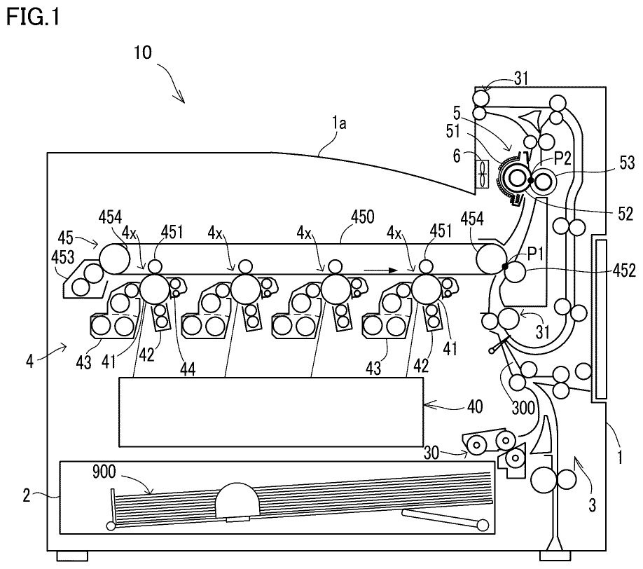

As shown in FIG. 1, the image forming apparatus 10 includes a sheet storing portion 2, a sheet conveying device 3, and a printing device 4. The sheet conveying device 3 and the printing device 4 are housed in a main body 1 which is a housing. The main body 1 includes a main body frame 1x that forms a skeleton of the main body 1 and an exterior member attached to the main body frame 1x.

The sheet storing portion 2 is capable of storing a plurality of sheets 900. The sheet conveying device 3 includes a sheet feed device 30 and a plurality of conveying roller pairs 31.

The sheet feed device 30 sends out the sheets 900 stored in the sheet storing portion 2 one by one to a conveying path 300. The conveying path 300 is a path for the sheets 900.

The plurality of conveying roller pairs 31 convey the sheet 900 along the conveying path 300. One pair out of the plurality of conveying roller pairs 31 discharges the sheet 900 on which an image has been formed from the conveying path 300 onto a discharge tray 1a.

The printing device 4 executes the print processing on the sheet 900 conveyed along the conveying path 300. The image formed on the sheet 900 is a toner image.

The printing device 4 includes a laser scanning unit 40, one or more image forming portions 4x, a transfer device 45, and a fixing device 5. The image forming portion 4x includes a photoconductor 41, a charging device 42, a developing device 43, and a drum cleaning device 44.

The charging device 42 charges a surface of the photoconductor 41. The laser scanning unit 40 scans beam light on the charged surface of the photoconductor 41. Thus, the laser scanning unit 40 forms an electrostatic latent image on the surface of the photoconductor 41.

The developing device 43 supplies toner to the surface of the photoconductor 41 to develop the electrostatic latent image into a toner image. The transfer device 45 transfers the toner image formed on the surface of the photoconductor 41 onto the sheet 900.

The transfer device 45 transfers the electrostatic latent image onto the sheet 900 at a transfer position P1 on the conveying path 300.

In the present embodiment, the printing device 4 is a tandem-type color printing device including the plurality of image forming portions 4x. In addition, the transfer device 45 includes an intermediate transfer belt 450, a plurality of primary transfer devices 451, a secondary transfer device 452, and a belt cleaning device 453.

In the example shown in FIG. 1, the printing device 4 includes four image forming portions 4x respectively corresponding to the four colors of toner, that is, yellow, magenta, cyan, and black. The transfer device 45 includes four primary transfer devices 451 respectively corresponding to the four image forming portions 4x.

The intermediate transfer belt 450 is rotatably supported by a plurality of support rollers 454. One of the plurality of support rollers 454 rotates by being driven by a belt drive device (not shown). Thus, the intermediate transfer belt 450 rotates.

Each of the primary transfer devices 451 transfers the toner image formed on the surface of the photoconductor 41 in each of the image forming portions 4x onto a surface of the intermediate transfer belt 450. Thus, a synthetic toner image in which the toner images of the four colors are combined is formed on the surface of the intermediate transfer belt 450.

The intermediate transfer belt 450 rotates while carrying the synthetic toner image. The secondary transfer device 452 transfers the synthetic toner image formed on the surface of the intermediate transfer belt 450 onto the sheet 900 at the transfer position P1.

The drum cleaning device 44 removes primary waste toner from the surface of the photoconductor 41. The primary waste toner is toner remaining at a portion of the surface of the photoconductor 41 that has passed through the primary transfer device 451.

The belt cleaning device 453 removes secondary waste toner from the surface of the intermediate transfer belt 450. The secondary waste toner is toner remaining at a portion of the surface of the intermediate transfer belt 450 that has passed through the secondary transfer device 452.

The fixing device 5 applies heat and pressure to the synthetic toner image formed on the sheet 900 at a fixing position P2 on the conveying path 300. Thus, the fixing device 5 fixes the synthetic toner image onto the sheet 900. The fixing position P2 is a position on a downstream side of the transfer position P1 in a sheet conveying direction.

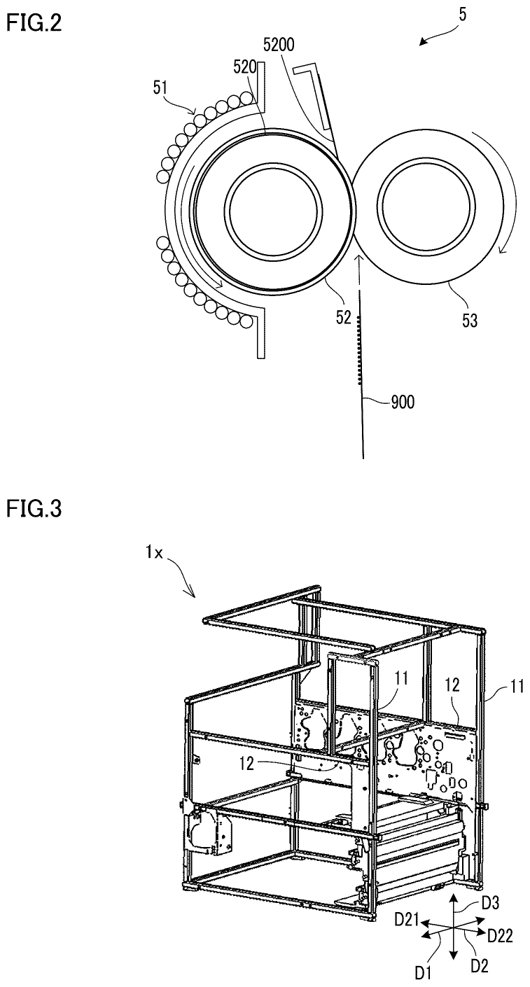

As shown in FIG. 2, the fixing device 5 includes a heater 51, a fixing belt 52, a fixing roller 520, a pressure roller 53, and a sheet separation member 5200.

The fixing belt 52 is a flexible cylindrical member that incorporates the fixing roller 520 therein. The fixing belt 52 is heated by the heater 51.

The fixing roller 520 is a cylindrical member that supports the fixing belt 52 from an inner side. The fixing roller 520 is supported rotatably. The fixing belt 52 is capable of rotating together with the fixing roller 520.

The fixing belt 52 includes a conductive base material, an elastic layer formed on an outer circumference of the base material, and a release layer formed on an outer circumference of the elastic layer.

The heater 51 is arranged opposed to an outer circumference surface of the fixing belt 52, and heats the fixing belt 52. In the present embodiment, the heater 51 is a heating device that uses an electromagnetic induction heating system. The heater 51 mainly heats the base material of the fixing belt 52 by electromagnetic induction. It is noted that, for example, a halogen heater or the like may be adopted as the heater 51.

The pressure roller 53 is supported rotatably. The pressure roller 53 is driven by a drive device (not shown) to thus rotate. The fixing belt 52 and the fixing roller 520 rotate in conjunction with the pressure roller 53.

The fixing belt 52 heats the toner image formed on the sheet 900. The pressure roller 53 biases the sheet 900 toward the fixing belt 52, to thus pressurize the toner image toward the sheet 900.

It is noted that the fixing belt 52 is an example of a fixing member that is heated by the heater 51. The pressure roller 53 is an example of a pressure member that biases the sheet 900 toward the fixing belt 52.

When the sheet 900 adheres onto the fixing belt 52, the sheet separation member 5200 peels off the sheet 900 from the fixing belt 52.

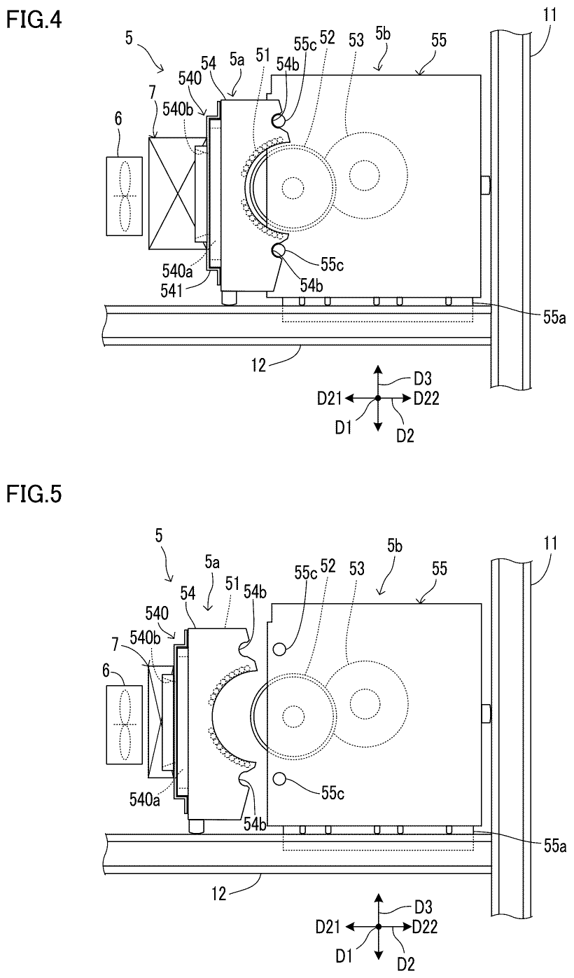

In the present embodiment, the fixing device 5 is sectioned into a heating unit 5a and a fixing unit 5b (see FIG. 4 and FIG. 5). The heating unit 5a is arranged in the main body 1 along a first direction D1. The fixing unit 5b is also arranged in the main body 1 along the first direction D1.

In other words, the heating unit 5a and the fixing unit 5b are arranged while longitudinal directions thereof are provided along the first direction D1.

The heating unit 5a and the fixing unit 5b are arranged next to each other in a second direction D2. In other words, the second direction D2 is an arrangement direction of the heating unit 5a and the fixing unit 5b. The second direction D2 is a direction orthogonal to the first direction D1.

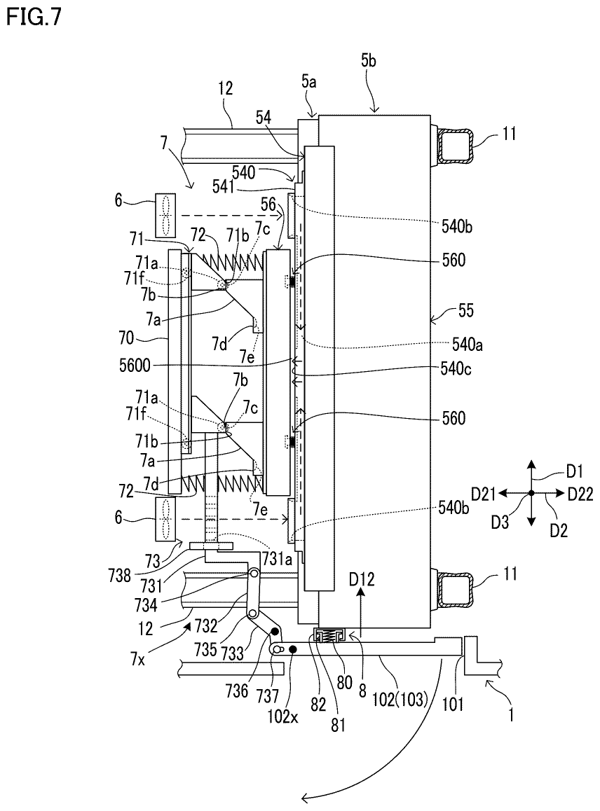

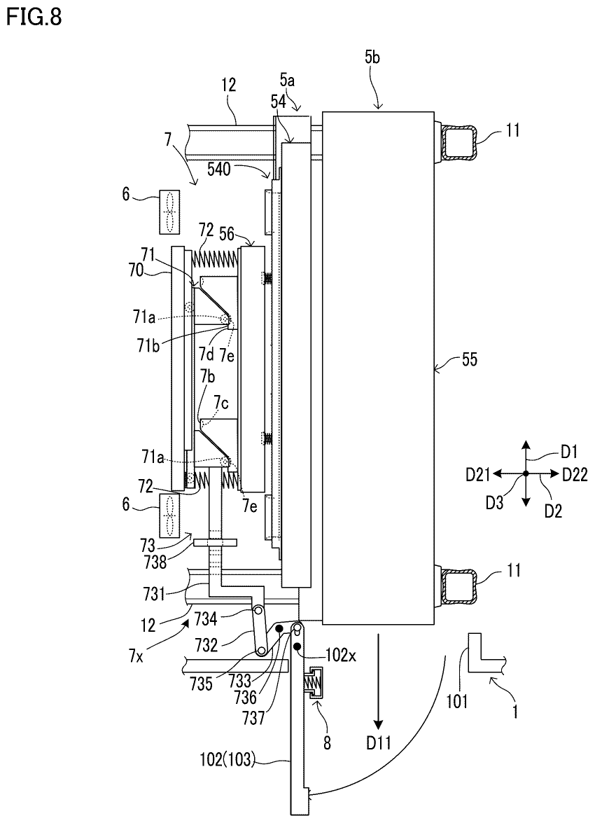

In descriptions below, one side of the second direction D2 will be referred to as a first side D21, and the other side of the second direction D2 will be referred to as a second side D22 (see FIG. 3 to FIG. 5 and FIG. 7 to FIG. 12). The heating unit 5a is arranged on the first side D21 with respect to the fixing unit 5b (see FIG. 4, FIG. 5, FIG. 7, and FIG. 8).

The heating unit 5a includes the heater 51 and a first support member 54. The fixing unit 5b includes the fixing belt 52, the fixing roller 520, the pressure roller 53, and a second support member 55.

The first support member 54 is a member that supports the heater 51. The second support member 55 is a member that supports the fixing belt 52, the fixing roller 520, and the pressure roller 53. The fixing belt 52 is supported by the second support member 55 via the fixing roller 520.

The main body frame 1x is formed by combining a plurality of metal pipes (see FIG. 3). The heating unit 5a and the fixing unit 5b are supported by the main body frame 1x. The fixing unit 5b is arranged on the second side D22 of the heating unit 5a in the second direction D2.

The plurality of metal pipes constituting the main body frame 1x include restriction portions 11 and lower support portions 12 (see FIG. 3 to FIG. 5).

In the present embodiment, the restriction portions 11 are two support pipes that are formed to extend in a vertical direction D3 and are arranged with an interval in the first direction D1 (see FIG. 3). The vertical direction D3 is an up-down direction.

The lower support portions 12 are two beam pipes that are formed to extend in the second direction D2 below the heating unit 5a and the fixing unit 5b and are arranged with an interval in the first direction D1 (see FIG. 3).

The heating unit 5a and the fixing unit 5b are placed on the lower support portions 12 while longitudinal directions thereof are provided along the first direction D1 (see FIG. 7 and FIG. 8). In other words, the lower support portions 12 support the heating unit 5a and the fixing unit 5b from below.

The heating unit 5a is capable of moving along the second direction D2 on the lower support portions 12. Specifically, the heating unit 5a is capable of moving between a reference position provided along the fixing unit 5b and an evacuation position that is farther away from the fixing unit 5b toward the first side D21 than the reference position. The fixing unit 5b is arranged between the heating unit 5a and the restriction portions 11 (see FIG. 4 and FIG. 5).

When the heating unit 5a is present at the evacuation position, the fixing unit 5b can be drawn out from inside the main body 1 along the first direction D1 (see FIG. 5 and FIG. 8).

The main body 1 includes an exposure opening 101 from which the inside is exposed to the outside (see FIG. 7 and FIG. 8). The fixing unit 5b is arranged along the first direction D1 on an inner side of the exposure opening 101 in the main body 1. The heating unit 5a is arranged along the first direction D1 inside the main body 1 while being arranged next to the fixing unit 5b in the second direction D2 (see FIG. 7 and FIG. 8).

The exposure opening 101 is an opening that opens one end of the fixing unit 5b in the first direction D1 to the outside of the main body 1. The image forming apparatus 10 includes a cover member 102 capable of opening and closing the exposure opening 101 (see FIG. 7 and FIG. 8).

The cover member 102 is supported by a first support shaft 102x. Thus, the cover member 102 can rotate about the first support shaft 102x. The cover member 102 is capable of rotating between a closing position at which the exposure opening 101 is closed and an opening position at which the exposure opening 101 is opened.

FIG. 7 shows the cover member 102 positioned at the closing position and the fixing device 5, and FIG. 8 shows the cover member 102 positioned at the opening position and the fixing device 5.

When the cover member 102 is positioned at the closing position, the cover member 102 is retained at the closing position by a lock mechanism (not shown). When the lock by the lock mechanism is released, the cover member 102 can be rotated from the closing position to the opening position.

When the cover member 102 is present at the opening position, the fixing unit 5b can be drawn out from the main body 1 through the exposure opening 101 (see FIG. 8).

Incidentally, it is important that the heating unit 5a is cooled efficiently in order to prevent an adverse effect of heat on peripheral devices of the fixing device 5 in the image forming apparatus 10.

Meanwhile, in order to enable the fixing unit 5b to be drawn out from the main body 1, the image forming apparatus 10 includes a unit movement mechanism 7 (see FIG. 7 and FIG. 8). The unit movement mechanism 7 causes the heating unit 5a to move between the reference position and the evacuation position.

The unit movement mechanism 7 is arranged on a side opposite to the fixing unit 5b side in the second direction D2 with respect to the heating unit 5a. That is, the unit movement mechanism 7 is arranged on the first side D21 of the second direction D2 with respect to the heating unit 5a. It is desirable to efficiently cool the heating unit 5a without the unit movement mechanism 7 becoming an obstacle.

The image forming apparatus 10 has a configuration for efficiently cooling the heating unit 5a without the unit movement mechanism 7 becoming an obstacle.

The image forming apparatus 10 includes a pair of fans 6 that are spaced apart from each other in the first direction D1 and blow air toward the heating unit 5a (see FIG. 7 and FIG. 8). The pair of fans 6 are arranged on the first side D21 of the second direction D2 with respect to the unit movement mechanism 7 in the main body 1 (see FIG. 1, FIG. 4, FIG. 5, FIG. 7, and FIG. 8). In other words, the pair of fans 6 are arranged on a side opposite to the heating unit 5a side in the second direction D2 with respect to the unit movement mechanism 7.

### [Configuration of Unit Movement Mechanism 7]

The image forming apparatus 10 includes the unit movement mechanism 7 and an operation member 103 coupled to the unit movement mechanism 7 (see FIG. 7 and FIG. 8). In the present embodiment, the cover member 102 doubles as the operation member 103.

The operation member 103 is capable of moving in a first operation direction or a second operation direction when operated. The operation member 103 is arranged at one end of the main body 1 in the first direction D1 (see FIG. 7 and FIG. 8).

In the present embodiment, the first operation direction is a movement direction of the cover member 102 when closing the cover member 102. The second operation direction is a movement direction of the cover member 102 when opening the cover member 102.

In other words, the first operation direction is a direction in which the cover member 102 moves from the opening position to the closing position. The second operation direction is a direction in which the cover member 102 moves from the closing position to the opening position.

The unit movement mechanism 7 causes the heating unit 5a to move along the second direction D2 in conjunction with the movement of the operation member 103.

The unit movement mechanism 7 causes the heating unit 5a to move from the evacuation position to the reference position in conjunction with the movement of the operation member 103 in the first operation direction (see FIG. 7). On the other hand, the unit movement mechanism 7 causes the heating unit 5a to move from the reference position to the evacuation position in conjunction with the movement of the operation member 103 in the second operation direction (see FIG. 8).

The unit movement mechanism 7 includes a unit coupling member 56 and a link mechanism 7x. The unit coupling member 56 is coupled to the heating unit 5a. The link mechanism 7x transmits the movement of the operation member 103 to the unit coupling member 56.

The heating unit 5a further includes a duct forming member 541 attached to a surface of the first support member 54 on the first side D21 (see FIG. 7 and FIG. 8). The heating unit 5a includes a ventilation duct 540 constituted of the duct forming member 541 and the first support member 54 (see FIG. 7 and FIG. 8).

The ventilation duct 540 includes a hollow portion 540a formed between the first support member 54 and the duct forming member 541, a pair of inflow openings 540b that are in communication with the hollow portion 540a, and a discharge opening 540c that is in communication with the hollow portion 540a (see FIG. 7). The pair of inflow openings 540b and the discharge opening 540c are openings formed in the duct forming member 541.

The hollow portion 540a is formed along the first direction D1 (see FIG. 7). That is, the hollow portion 540a is formed along the heater 51 with the first direction D1 being a longitudinal direction thereof.

The pair of inflow openings 540b are formed to respectively oppose the pair of fans 6. That is, the pair of fans 6 and the pair of inflow openings 540b are respectively arranged on both outer sides of the unit coupling member 56 in the first direction D1.

The pair of fans 6 blow air toward the second side D22 of the second direction D2. The pair of inflow openings 540b are opened toward the first side D21 of the second direction D2 at positions respectively corresponding to the pair of fans 6 in the first direction D1.

The discharge opening 540c is formed between the pair of inflow openings 540b in the first direction D1. In the present embodiment, the discharge opening 540c is opened toward the first side D21 of the second direction D2.

The unit coupling member 56 is coupled to the heating unit 5a at a position between the pair of inflow openings 540b in the first direction D1 while a gap 5600 is provided between the unit coupling member 56 and the discharge opening 540c (see FIG. 7). The discharge opening 540c is opened toward the gap 5600.

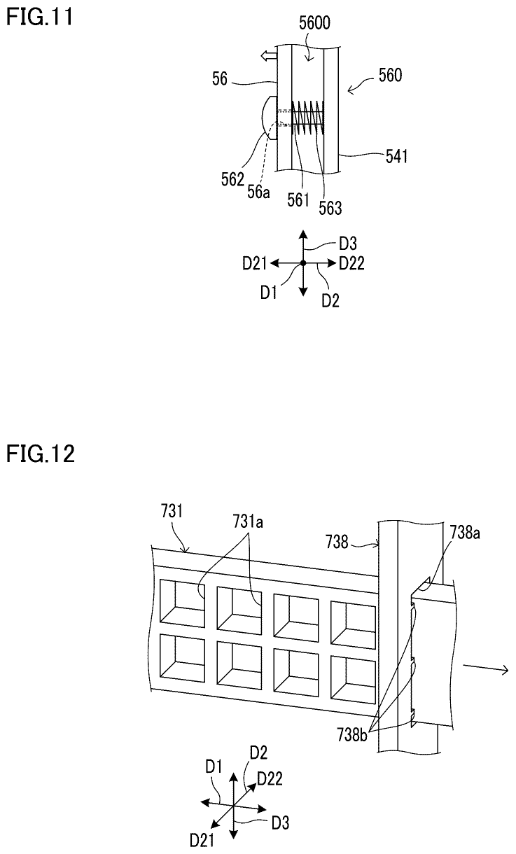

In the present embodiment, the unit coupling member 56 is coupled to the duct forming member 541 of the heating unit 5a by a coupling mechanism 560 (see FIG. 7, FIG. 10, and FIG. 11).

The cooling air sent out by the pair of fans 6 flows into the hollow portion 540a via the pair of inflow openings 540b. Furthermore, the cooling air efficiently cools the heating unit 5a while flowing through the hollow portion 540a from both end portions in the first direction D1 toward a center portion in the first direction D1.

Further, after cooling the heating unit 5a, the cooling air flows out of the hollow portion 540a into the gap 5600 via the discharge opening 540c. The cooling air flows out of the gap 5600 mainly along the vertical direction D3.

Therefore, the heating unit 5a is efficiently cooled by the cooling air that flows through a path in which the unit movement mechanism 7 does not become an obstacle.

The link mechanism 7x includes a guide member 70, a movable member 71, a first bias member 72, and a first direction movement mechanism 73.

The first bias member 72 biases the heating unit 5a toward the first side D21. Specifically, the first bias member 72 is one or more elastic members that bias the heating unit 5a toward the first side D21. For example, the elastic member is a coil spring, a leaf spring, or the like.

In the example shown in FIG. 7 and FIG. 8, the first bias member 72 is two tension springs that elastically bias the heating unit 5a toward the first side D21.

The unit coupling member 56 includes tilted surfaces 7a. The tilted surfaces 7a are provided so as to face the first side D21 of the heating unit 5a. The tilted surfaces 7a are each a surface that is tilted from the second side D22 to the first side D21 with respect to the first direction D1. In the present embodiment, the tilted surfaces 7a are provided at two positions spaced apart from each other in the first direction D1 (see FIG. 7 and FIG. 8).

The movable member 71 is supported so as to be movable along the first direction D1. The guide member 70 guides the movable member 71 along the first direction D1. For example, the guide member 70 is supported by the main body frame 1x.

The movable member 71 includes one or more rollers 71a that are supported rotatably (see FIG. 7 to FIG. 9). The rollers 71a are provided at positions respectively corresponding to the tilted surfaces 7a in the movable member 71. In the present embodiment, the rollers 71a are provided at two positions spaced apart from each other in the first direction D1 (see FIG. 7 to FIG. 9). The rollers 71a roll while being in contact with the tilted surfaces 7a.

The first direction movement mechanism 73 causes the movable member 71 to move along the first direction D1 in conjunction with the movement of the operation member 103. In the present embodiment, the first direction movement mechanism 73 is a mechanism that converts a rotation of the operation member 103 into a linear movement along the first direction D1.

The first direction movement mechanism 73 includes a first link member 731, a second link member 732, and a third link member 733 (see FIG. 7 and FIG. 8).

One end of the first link member 731 is connected to the movable member 71, and the other end of the first link member 731 is coupled to one end of the second link member 732 by a first coupling shaft 734. The other end of the second link member 732 is connected to one end of the third link member 733 by a second coupling shaft 735. The other end of the third link member 733 is coupled to one end of the operation member 103 by a third coupling shaft 737.

The third link member 733 is rotatably supported by a second support shaft 736.

In the present embodiment, when the operation member 103 moves from the opening position to the closing position, the first direction movement mechanism 73 causes the movable member 71 to move toward the rear side along the first direction D1. Further, when the operation member 103 moves from the closing position to the opening position, the first direction movement mechanism 73 causes the movable member 71 to move toward the front side along the first direction D1.

As described above, the movement direction from the opening position to the closing position is the first operation direction. The movement direction from the closing position to the opening position is the second operation direction.

In descriptions below, an end portion of the tilted surface 7a on the second side D22 will be referred to as a base end portion of the tilted surface 7a, and an end portion of the tilted surface 7a on the first side D21 will be referred to as a terminal portion of the tilted surface 7a. The base end portion is an example of a portion of the tilted surface 7a on the second side D22. The terminal portion is an example of a portion of the tilted surface 7a on the first side D21.

When the movable member 71 moves in conjunction with the movement of the operation member 103 in the first operation direction, the roller 71a rolls from the base end portion to the terminal portion on the tilted surface 7a. By rolling from the base end portion to the terminal portion on the tilted surface 7a, the roller 71a presses the tilted surface 7a toward the second side D22. By pressing the tilted surface 7a toward the second side D22, the roller 71a causes the heating unit 5a to move toward the second side D22 against a bias force of the first bias member 72.

Neither the heating unit 5a nor the fixing unit 5b is fixed to the main body frame 1x by a fixing tool such as a screw.

The restriction portions 11 restrict a movement range of the fixing unit 5b toward the second side D22. By the rollers 71a causing the heating unit 5a to move toward the second side D22, the fixing unit 5b and the heating unit 5a are sandwiched between the movable member 71 and the restriction portions 11 (see FIG. 4 and FIG. 7).

FIG. 7 shows the unit movement mechanism 7 in a biased state where the movable member 71 is biasing the heating unit 5a and the fixing unit 5b toward the restriction portions 11. FIG. 4 and FIG. 7 show the fixing device 5 in a proximity state where the heating unit 5a is retained in proximity to the fixing unit 5b by the unit movement mechanism 7.

The fixing unit 5b and the heating unit 5a are positioned in the second direction D2 by being sandwiched between the movable member 71 and the restriction portions 11.

In other words, when the movable member 71 moves in conjunction with the movement of the operation member 103 in the first operation direction, the fixing unit 5b and the heating unit 5a are sandwiched between the movable member 71 and the restriction portions 11 to thus be positioned in the second direction D2.

The first support member 54 includes a plurality of concave first fitting portions 54b that are opened toward the second side D22 (see FIG. 4 and FIG. 5). The second support member 55 includes a plurality of convex second fitting portions 55c that can be respectively fit into the plurality of first fitting portions 54b (see FIG. 4 and FIG. 5).

By the unit movement mechanism 7 causing the heating unit 5a to move toward the second side D22, the plurality of first fitting portions 54b and the plurality of second fitting portions 55c fit (see FIG. 4).

By the plurality of first fitting portions 54b and the plurality of second fitting portions 55c fitting with one another, a relative movement of the heating unit 5a and the fixing unit 5b in the vertical direction D3 is restricted.

It is noted that alternatively, the second support member 55 may include the first fitting portions 54b, and the first support member 54 may include the second fitting portions 55c.

On the other hand, when the movable member 71 moves in conjunction with the movement of the operation member 103 in the second operation direction, the roller 71a rolls from the terminal portion to the base end portion on the tilted surface 7a, and the first bias member 72 causes the heating unit 5a to move toward the first side D21.

FIG. 8 shows the unit movement mechanism 7 in a pulled state where the first bias member 72 is pulling the heating unit 5a toward the first side D21. FIG. 5 and FIG. 8 show the fixing device 5 in a separated state where the heating unit 5a is separated from the fixing unit 5b toward the first side D21 by the unit movement mechanism 7. The separated state is a state where the heating unit 5a is present at the evacuation position.

In the present embodiment, the movable member 71 further includes first contact surfaces 71b (see FIG. 7 to FIG. 9). The unit coupling member 56 further includes second contact surfaces 7b respectively corresponding to the first contact surfaces 71b and first concave portions 7c respectively corresponding to the rollers 71a (see FIG. 7 and FIG. 8).

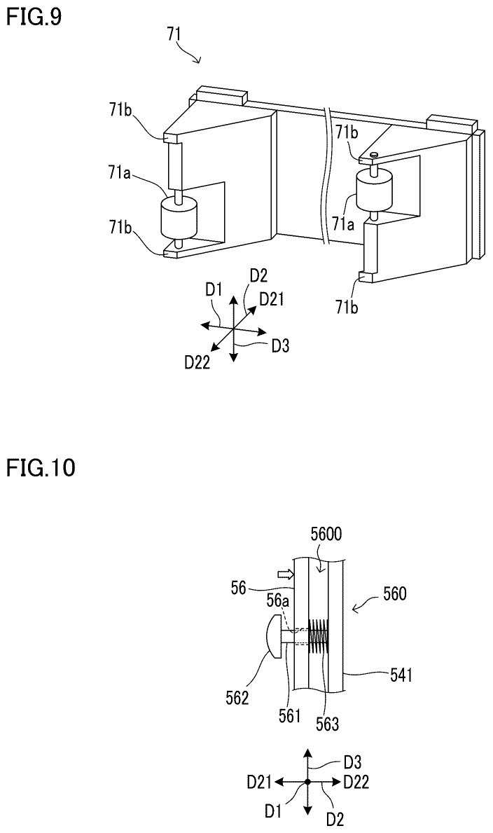

The first contact surface 71b is a surface that faces the second side D22 and is capable of coming into contact with the second contact surface 7b of the unit coupling member 56. For example, the first contact surfaces 71b are formed at three or more positions in the movable member 71. In the example shown in FIG. 9, the first contact surfaces 71b are formed at four positions in the movable member 71.

The second contact surface 7b is a surface that faces the first side D21 and is capable of coming into contact with the first contact surface 71b of the movable member 71. The second contact surfaces 7b are formed at positions respectively corresponding to the first contact surfaces 71b in the unit coupling member 56.

The first concave portion 7c faces the first side D21 and is arranged adjacent to the terminal portion of the tilted surface 7a in the first direction D1 (see FIG. 7 and FIG. 8). The first concave portion 7c is provided at positions respectively corresponding to the rollers 71a in the unit coupling member 56. In the present embodiment, the first concave portions 7c are provided at two positions in the unit coupling member 56.

A part of the roller 71a can be inserted into the first concave portion 7c. Specifically, a part of the roller 71a including an edge on the second side D22 can be inserted into the first concave portion 7c.

When the movable member 71 moves in conjunction with the movement of the operation member 103 in the first operation direction, the following first operation is caused. In the first operation, after the roller 71a rolls from the base end portion to the terminal portion on the tilted surface 7a, a part of the roller 71a enters the first concave portion 7c, and the first contact surface 71b abuts against the second contact surface 7b (see FIG. 7).

By the first contact surface 71b abutting against the second contact surface 7b, the fixing unit 5b and the heating unit 5a are sandwiched between the movable member 71 and the restriction portions 11. Thus, the fixing unit 5b and the heating unit 5a are positioned in the second direction D2.

Generally, an allowance is formed between the roller 71a and a rotation shaft of the roller 71a. The fixing unit 5b and the heating unit 5a are positioned in a state where the first contact surfaces 71b and the second contact surfaces 7b are in contact with one another, and thus the fixing unit 5b and the heating unit 5a are positioned with high accuracy.

Furthermore, when the fixing unit 5b and the heating unit 5a are positioned by the contact between the first contact surfaces 71b and the second contact surfaces 7b, no large force is applied to the rollers 71a. Therefore, durability of the rollers 71a is improved.

On the other hand, when the movable member 71 moves in conjunction with the movement of the operation member 103 in the second operation direction, the following second operation is caused. In the second operation, the roller 71a is detached from the first concave portion 7c, and the first contact surface 71b moves away from the second contact surface 7b. After that, the roller 71a rolls from the terminal portion to the base end portion on the tilted surface 7a (see FIG. 8).

In the present embodiment, the unit coupling member 56 further includes third contact surfaces 7d respectively corresponding to the first contact surfaces 71b and second concave portions 7e respectively corresponding to the rollers 71a (see FIG. 7 and FIG. 8).

The third contact surface 7d is a surface that faces the first side D21 and is capable of coming into contact with the first contact surface 71b of the movable member 71. The second contact surface 7b is formed at a position corresponding to the first contact surface 71b in the unit coupling member 56.

The second concave portion 7e faces the first side D21 and is arranged adjacent to the base end portion of the tilted surface 7a in the first direction D1 (see FIG. 7 and FIG. 8). The second concave portion 7e is provided at a position corresponding to the roller 71a in the unit coupling member 56. In the present embodiment, the second concave portions 7e are provided at two positions in the unit coupling member 56.

A part of the roller 71a can be inserted into the second concave portion 7e. Specifically, a part of the roller 71a including an edge on the second side D22 can be inserted into the second concave portion 7e.

When the movable member 71 moves in conjunction with the movement of the operation member 103 in the second operation direction, the following third operation is caused. In the third operation, the roller 71a is detached from the first concave portion 7c and rolls from the terminal portion to the base end portion on the tilted surface 7a. After that, a part of the roller 71a enters the second concave portion 7e, and the first contact surface 71b abuts against the third contact surface 7d (see FIG. 8).

Therefore, when the heating unit 5a is separated from the fixing unit 5b toward the first side D21, the force of the first bias member 72 is not applied to the rollers 71a. Therefore, the durability of the rollers 71a is improved.

On the other hand, when the movable member 71 moves in conjunction with the movement of the operation member 103 in the first operation direction, the following fourth operation is caused. In the fourth operation, the roller 71a is detached from the second concave portion 7e, and the first contact surface 71b moves away from the third contact surface 7d. After that, the roller 71a rolls from the base end portion to the terminal portion on the tilted surface 7a (see FIG. 7).

In the image forming apparatus 10, by the action of the rollers 71a, the heating unit 5a can smoothly approach or move away from the fixing unit 5b.

In the present embodiment, the movable member 71 further includes rollers 71f (see FIG. 7). The rollers 71f are in contact with the guide member 70. When the movable member 71 moves along the first direction D1, the rollers 71f roll on the surface of the guide member 70.

By the action of the rollers 71f, the heating unit 5a can smoothly approach or move away from the fixing unit 5b.

The coupling mechanism 560 includes a shaft portion 561, an engagement portion 562, and a second bias member 563 (see FIG. 10 and FIG. 11).

The shaft portion 561 is formed to protrude toward the first side D21 of the second direction D2 from the heating unit 5a. In the present embodiment, a first end of the shaft portion 561 is fixed to the duct forming member 541.

The shaft portion 561 is inserted into a through-hole 56a that is formed in the unit coupling member 56 and is provided along the second direction D2. The engagement portion 562 is formed at a second end of the shaft portion 561. The engagement portion 562 is larger than an inner diameter of the through-hole 56a.

The engagement portion 562 engages with an edge portion of the through-hole 56a in the unit coupling member 56 when the unit coupling member 56 moves toward the first side D21 of the second direction D2, to thus prevent the shaft portion 561 from coming out of the through-hole 56a.

The second bias member 563 is arranged between the unit coupling member 56 and the heating unit 5a. Thus, the second bias member 563 functions as a spacer that forms the gap 5600 between the unit coupling member 56 and the heating unit 5a.

In the present embodiment, the second bias member 563 is arranged between the unit coupling member 56 and the duct forming member 541 so as to form the gap 5600 between the unit coupling member 56 and the duct forming member 541.

When the unit movement mechanism 7 is in the biased state, the engagement with the unit coupling member 56 by the engagement portion 562 is released, and the second bias member 563 elastically biases the duct forming member 541 toward the second side D22 while forming the gap 5600 (see FIG. 10). Thus, the heating unit 5a moves from the evacuation position to the reference position to be positioned at the reference position.

On the other hand, when the unit movement mechanism 7 is in the pulled state, the engagement portion 562 engages with the unit coupling member 56, and a force that pulls the duct forming member 541 toward the first side D21 of the second direction D2 acts on the duct forming member 541 from the shaft portion 561. Thus, the heating unit 5a moves from the reference position to the evacuation position.

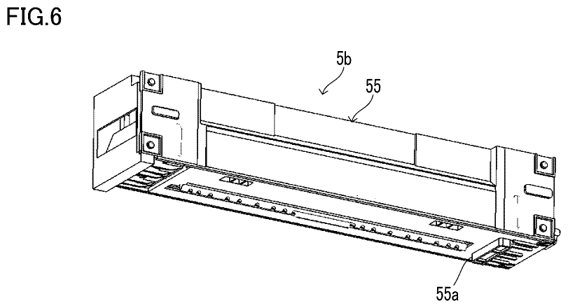

Further, the image forming apparatus 10 further includes a first direction bias mechanism 8 attached to an inner surface of the cover member 102 (see FIG. 7 and FIG. 8). Furthermore, the second support member 55 of the fixing unit 5b includes a protrusion portion 55a protruding from a lower surface of the second support member 55 (see FIG. 4 to FIG. 6).

The first direction bias mechanism 8 includes a spring 80, a spring case 81, and a cap portion 82 (see FIG. 7).

The spring case 81 houses the spring 80. The cap portion 82 is attached to be movable with respect to the spring case 81. The spring 80 is an example of an elastic member.

When the cover member 102 is positioned at the closing position, the spring 80 is sandwiched between the cover member 102 and the second support member 55 of the fixing unit 5b. In the present embodiment, the spring 80 and the cap portion 82 are sandwiched between the cover member 102 and the second support member 55.

By the spring 80 being sandwiched between the cover member 102 and the second support member 55, the second support member 55 is biased in an attachment direction D12 by the elastic force (see FIG. 7). The attachment direction D12 is a direction opposite to a drawing direction D11 of the fixing unit 5b.

Furthermore, by a force that the second support member 55 receives from the spring 80 when the cover member 102 is positioned at the closing position, the protrusion portion 55a abuts against a beam pipe 12b which is one of the lower support portions 12.

The fixing unit 5b is positioned in the first direction D1 by the action of the spring 80 and the protrusion portion 55a. It is noted that the first direction bias mechanism 8 may alternatively be attached to the second support member 55 of the fixing unit 5b.

The first link member 731 moves along the first direction D1 in conjunction with the movement of the operation member 103. The first link member 731 is an example of a first direction link member.

The first link member 731 is arranged along the first direction D1 from an end portion of the main body 1 in the first direction D1 on a side where the operation member 103 is arranged to a position opposing the unit coupling member 56 (see FIG. 7 and FIG. 8).

Therefore, there is a fear that the first link member 731 will inhibit the flow of air from one of the pair of fans 6 toward one of the pair of inflow openings 540b.

In the present embodiment, one or more ventilation openings 731a are formed at a portion of the first link member 731 that is positioned between one of the pair of fans 6 and one of the pair of inflow openings 540b (see FIG. 7 and FIG. 11). In the example shown in FIG. 11, a plurality of ventilation openings 731a are formed in the first link member 731.

The air blown out from one of the pair of fans 6 flows smoothly toward one of the pair of inflow openings 540b via the ventilation openings 731a.

The link mechanism 7x further includes a restriction frame member 738 formed with a through-hole 738a through which the first link member 731 penetrates in the first direction D1 (see FIG. 12). The restriction frame member 738 restricts the movement of the first link member 731 in the second direction D2 and guides the first link member 731 along the first direction D1.

The restriction frame member 738 includes a plurality of guide ribs 738b that protrude from an edge portion of the through-hole 738a toward the through-hole 738a (see FIG. 12). The plurality of guide ribs 738b abut against edge portions of the ventilation openings 731a in the first link member 731. Thus, when the first link member 731 moves along the first direction D1, the edge portions of the ventilation openings 731a in the first link member 731 slide against the plurality of guide ribs 738b.

The plurality of guide ribs 738b smoothly guide the first link member 731 along the first direction D1 without getting caught in the ventilation openings 731a.

### [Notes of Disclosure]

Hereinafter, a general outline of the disclosure extracted from the embodiment described above will be noted. It is noted that the respective configurations and processing functions described in the notes below can be sorted and arbitrarily combined as appropriate.

### <Note 1>

An image forming apparatus, including:
a main body formed with an exposure opening through which an inside is exposed to an outside;
a fixing unit which is arranged along a first direction on an inner side of the exposure opening in the main body, and includes a fixing member which is heated and a pressure member which biases a sheet toward the fixing member;
a heating unit which is arranged in the main body along the first direction while being arranged next to the fixing unit in a second direction orthogonal to the first direction, and includes a heater which heats the fixing member;
an operation member capable of moving by being operated;
a unit movement mechanism which is arranged on a side opposite to a side of the fixing unit in the second direction with respect to the heating unit in the main body, and causes the heating unit to move between a reference position provided along the fixing unit and an evacuation position farther away from the fixing unit than the reference position in conjunction with a movement of the operation member; and
a pair of fans which are arranged with an interval provided therebetween in the first direction on a side opposite to a side of the heating unit in the second direction with respect to the unit movement mechanism in the main body, and blow air toward the heating unit, in which
when the heating unit is present at the evacuation position, the fixing unit can be drawn out from inside the main body along the first direction,
the heating unit includes a ventilation duct including a hollow portion formed along the first direction, a pair of inflow openings which are formed opposite to the pair of fans and are in communication with the hollow portion, and a discharge opening which is formed between the pair of inflow openings in the first direction and is in communication with the hollow portion, and
the unit movement mechanism includes
a unit coupling member which is coupled to the heating unit while a gap is provided between the unit coupling member and the discharge opening at a position between the pair of inflow openings in the first direction, and
a link mechanism which transmits the movement of the operation member to the unit coupling member.

### <Note 2>

The image forming apparatus according to note 1, in which
the operation member is arranged at one end of the main body in the first direction,
the link mechanism includes
a first direction link member which is arranged along the first direction from an end portion of the main body in the first direction on a side where the operation member is arranged to a position opposing the unit coupling member, and moves along the first direction in conjunction with the movement of the operation member, and
the first direction link member is formed with a ventilation opening at a portion thereof positioned between one of the pair of fans and one of the pair of inflow openings.

### <Note 3>

The image forming apparatus according to note 2, in which
the link mechanism includes
a restriction frame member which is formed with a through-hole through which the first direction link member penetrates in the first direction, and restricts a movement of the first direction link member in the second direction,
the restriction frame member includes a plurality of guide ribs which protrude from an edge portion of the through-hole toward the through-hole and abut against an edge portion of the ventilation opening in the first direction link member, and
when the first direction link member moves along the first direction, the edge portion of the ventilation opening in the first direction link member slides against the plurality of guide ribs.

### <Note 4>

The image forming apparatus according to any one of notes 1 to 3, in which
the main body includes a cover member which is rotatable between a closing position at which the exposure opening is closed and an opening position at which the exposure opening is opened,
the cover member doubles as the operation member,
when the cover member moves from the closing position to the opening position, the link mechanism causes the heating unit to move from the reference position to the evacuation position, and
further, when the cover member moves from the opening position to the closing position, the link mechanism causes the heating unit to move from the evacuation position to the reference position.

### <Note 5>

The image forming apparatus according to any one of notes 1 to 4, in which
the heater is a heating device that uses an electromagnetic induction heating system.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus, comprising:
a main body formed with an exposure opening through which an inside is exposed to an outside;
a fixing unit which is arranged along a first direction on an inner side of the exposure opening in the main body, and includes a fixing member which is heated and a pressure member which biases a sheet toward the fixing member;
a heating unit which is arranged in the main body along the first direction while being arranged next to the fixing unit in a second direction orthogonal to the first direction, and includes a heater which heats the fixing member;
an operation member capable of moving by being operated;
a unit movement mechanism which is arranged on a side opposite to a side of the fixing unit in the second direction with respect to the heating unit in the main body, and causes the heating unit to move between a reference position provided along the fixing unit and an evacuation position farther away from the fixing unit than the reference position in conjunction with a movement of the operation member; and
a pair of fans which are arranged with an interval provided therebetween in the first direction on a side opposite to a side of the heating unit in the second direction with respect to the unit movement mechanism in the main body, and blow air toward the heating unit, wherein
when the heating unit is present at the evacuation position, the fixing unit can be drawn out from inside the main body along the first direction,
the heating unit includes a ventilation duct including a hollow portion formed along the first direction, a pair of inflow openings which are formed opposite to the pair of fans and are in communication with the hollow portion, and a discharge opening which is formed between the pair of inflow openings in the first direction and is in communication with the hollow portion, and
the unit movement mechanism includes
a unit coupling member which is coupled to the heating unit while a gap is provided between the unit coupling member and the discharge opening at a position between the pair of inflow openings in the first direction, and
a link mechanism which transmits the movement of the operation member to the unit coupling member.

2. The image forming apparatus according to claim 1, wherein
the operation member is arranged at one end of the main body in the first direction,
the link mechanism includes
a first direction link member which is arranged along the first direction from an end portion of the main body in the first direction on a side where the operation member is arranged to a position opposing the unit coupling member, and moves along the first direction in conjunction with the movement of the operation member, and
the first direction link member is formed with a ventilation opening at a portion thereof positioned between one of the pair of fans and one of the pair of inflow openings.

3. The image forming apparatus according to claim 2, wherein
the link mechanism includes
a restriction frame member which is formed with a through-hole through which the first direction link member penetrates in the first direction, and restricts a movement of the first direction link member in the second direction,
the restriction frame member includes a plurality of guide ribs which protrude from an edge portion of the through-hole toward the through-hole and abut against an edge portion of the ventilation opening in the first direction link member, and
when the first direction link member moves along the first direction, the edge portion of the ventilation opening in the first direction link member slides against the plurality of guide ribs.

4. The image forming apparatus according to claim 1, wherein
the main body includes a cover member which is rotatable between a closing position at which the exposure opening is closed and an opening position at which the exposure opening is opened,
the cover member doubles as the operation member,
when the cover member moves from the closing position to the opening position, the link mechanism causes the heating unit to move from the reference position to the evacuation position, and
further, when the cover member moves from the opening position to the closing position, the link mechanism causes the heating unit to move from the evacuation position to the reference position.

5. The image forming apparatus according to claim 1, wherein
the heater is a heating device that uses an electromagnetic induction heating system.
